(19) United States
(12) Patent Application Publication
(10) Pub. No.: US 2025/0029053 A1
(43) Pub. Date: Jan. 23, 2025

(54) MACHINE LEARNING MODEL FOR ADDING AN ORDER TO A SET OF EXISTING ORDERS BEING SERVICED BY A PICKER OF A FULFILLMENT SYSTEM

(71) Applicant: Maplebear Inc., San Francisco, CA (US)

(72) Inventors: Kevin Charles Ryan, San Francisco, CA (US); Krishna Kumar Selvam, San Francisco, CA (US); Tahmid Shahriar, New York, NY (US); Ajay Pankaj Sampat, San Francisco, CA (US); Shouvik Dutta, Alameda, CA (US); Sawyer Bowman, San Francisco, CA (US); Nicholas Rose, Toronto (CA); Ziwei Shi, San Francisco, CA (US)

(21) Appl. No.: 18/224,795

(22) Filed: Jul. 21, 2023

(51) Int. Cl. G06Q 10/0834; G06Q 10/083

(52) U.S. Cl. CPC G06Q 10/08345; G06Q 10/0838

(57) ABSTRACT

An online concierge system receives information describing the progress of a picker servicing a batch of existing orders and a service request for an order. The system identifies picker attributes of the picker and order attributes of the order and each existing order of the set and accesses a machine learning model trained to predict a likelihood the picker will accept an add-on request to add the order to the batch of existing orders. To predict the likelihood, the system applies the model to the picker attributes, the progress of the picker, and the order attributes. The system determines a cost associated with sending the add-on request to the picker based on the likelihood and assigns the order to a set of orders based on the cost. The system sends the add-on request to the picker responsive to determining the order is assigned to the batch of existing orders.

### BACKGROUND

Online concierge systems allow customers to place online delivery orders and select delivery timeframes during which the orders are to be delivered. The orders are then matched with pickers who service the orders (e.g., by driving to retailer locations, collecting items included in the orders, purchasing the items, and delivering the items to customers). As orders are received from customers, online concierge systems may assign the orders to sets of orders or “batches,” and information describing the batches are communicated to pickers who may accept the batches for servicing. However, rather than assigning an order to a batch of new orders, it may be more efficient for an online concierge system to add the order to a batch of existing orders being serviced by a picker and to have the picker service the order. For example, suppose that an order including items to be collected from a retailer location is received by an online concierge system and that a picker servicing a batch of existing orders is almost finished collecting items included in the batch from the retailer location. In this example, since the picker is already at the retailer location, it may be more efficient for the picker to service the order than for a different picker to service the order, especially if the order includes only a few items, if the delivery location for the order is close to or on the way to one or more delivery locations for the batch, etc.

However, it may not always be beneficial to add an order to a batch of existing orders being serviced by a picker. In the above example, suppose that a request to service the order is sent to the picker after the picker has already collected the items included in the batch of existing orders and that the picker has just left a congested parking lot for the retailer location. In this example, if the picker accepts the order for servicing, the picker will have to turn around, find a new parking spot, collect the items included in the order, etc., which may result in late delivery of the batch of existing orders. Additionally, in the above example, if the picker does not accept the order for servicing, it may have been more efficient for the online concierge system to send the request to service the order to one or more additional pickers since sending the request to the picker delayed its acceptance for servicing, which may result in late delivery of the order. As such, it may be difficult for online concierge systems to determine whether it would be beneficial or detrimental to send requests to service orders to pickers servicing batches of existing orders.

### SUMMARY

In accordance with one or more aspects of the disclosure, an online concierge system assigns a new order placed with the online concierge system to a batch of existing orders being serviced by a picker. More specifically, an online concierge system receives information describing the progress of a picker servicing a batch of existing orders and a service request for an order placed with the online concierge system. The online concierge system identifies a set of picker attributes of the picker and a set of order attributes of the order and each existing order included among the batch of existing orders and accesses a machine learning model trained to predict a likelihood that the picker will accept an add-on request to add the order to the batch of existing orders. To predict the likelihood, the online concierge system applies the machine learning model to a set of inputs including the set of picker attributes, the progress of the picker, and the set of order attributes. The online concierge system determines a cost associated with sending the add-on request to a client device associated with the picker based on the predicted likelihood and assigns the order to a batch of orders included among multiple batches of orders based on the determined cost, in which the batches of orders include the batch of existing orders being serviced by the picker. The online concierge system then determines whether the order is assigned to the batch of existing orders being serviced by the picker and sends the add-on request to the client device associated with the picker responsive to determining the order is assigned to the batch of existing orders being serviced by the picker.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for assigning a new order placed with an online concierge system to a batch of existing orders being serviced by a picker, in accordance with one or more embodiments.

FIG. 4 illustrates an example of information describing the progress of a picker servicing a batch of existing orders, in accordance with one or more embodiments.

FIG. 5 illustrates an example of assigning a new order to a batch of orders included among multiple batches of orders, in accordance with one or more embodiments.

FIG. 6 illustrates an example of an add-on request to add a new order to a batch of existing orders being serviced by a picker, in accordance with one or more embodiments.

### DETAILED DESCRIPTION

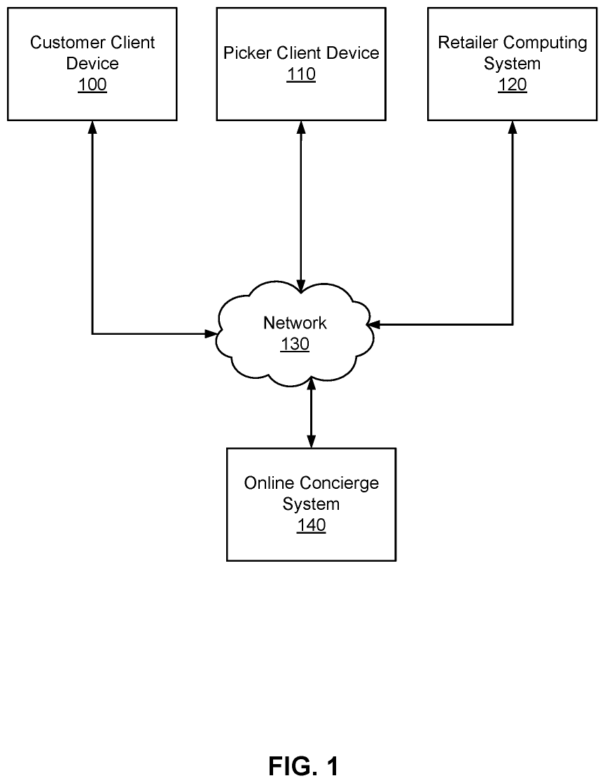

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or a desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, refers to a good or product that may be provided to the customer through the online concierge system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the customer has selected for an order but that has not yet been finalized for an order. The ordering interface allows a customer to update the shopping list, e.g., by changing the quantity of items, adding or removing items, or adding instructions for items that specify how the items should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the customer to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer location. The picker client device 110 presents the items that are included in the customer's order to the picker in a collection interface. The collection interface is a user interface that provides information to the picker identifying items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 provides instructions to a picker for delivering the items for a customer's order. For example, the picker client device 110 displays a delivery location from the order to the picker. The picker client device 110 also provides navigation instructions for the picker to travel from the retailer location to the delivery location. If a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140. Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 may provide item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a customer's order (e.g., as a commission).

The customer client device 100, the picker client device 110, the retailer computing system 120, and the online concierge system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

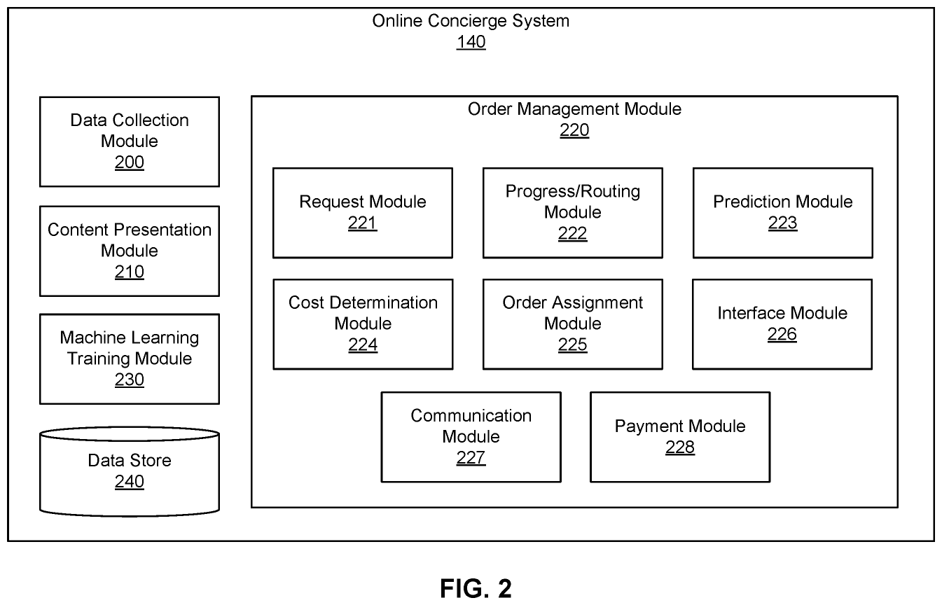

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer. As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

The data collection module 200 collects customer data, which is information or data describing characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the sizes, colors, weights, stock keeping units (SKUs), or serial numbers for the items. The item data may further include purchasing rules associated with each item, if they exist. For example, age-restricted items such as alcohol and tobacco are flagged accordingly in the item data. Item data may also include information that is useful for predicting the availability of items at retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or a customer client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online concierge system 140, a customer rating for the picker, the retailers from which the picker has collected items, or the picker's previous shopping history. In the above example, the picker's previous shopping history may describe a timespan during which the picker serviced each order, a time or a timespan during which the picker performed various tasks involved in servicing each order (e.g., collecting each item in the order, driving to a retailer location or a delivery location for the order, delivering the order, etc.), information identifying each order (e.g., an order number) serviced by the picker, etc. As an additional example, the picker data for a picker may include historical data describing service requests and add-on requests (described below) sent to a picker client device 110 associated with the picker, a location associated with the picker at the time each request was sent, the picker's response to each request, and information describing each order associated with the request, such as a payment amount associated with servicing the order (e.g., a payrate, a tip amount, etc.), a number of items included in the order, etc. In some embodiments, picker data also may include information associated with a picker that the data collection module 200 may determine based on other picker data for the picker, such as an average rate at which a picker collects items, an average number of hours a picker services orders (e.g., per day, on a given day of the week, etc.), or any other suitable types of information. Additionally, the picker data may include preferences expressed by the picker, such as their preferred retailers for collecting items, how far they are willing to travel to deliver items to a customer, how many items they are willing to collect at a time, timeframes within which the picker is willing to service orders, or payment information by which the picker is to be paid for servicing orders (e.g., a bank account). As noted above, the data collection module 200 may only collect data describing a user if the user has previously explicitly consented to the online concierge system 140 collecting data describing the user. For example, the data collection module 200 may only collect information describing an average number of hours a picker services orders per day or on a given day of the week and a payment amount associated with servicing a previous order if the picker opted in to allow the online concierge system 140 to collect such information. The data collection module 200 collects picker data from sensors of the picker client device 110 or from the picker's interactions with the online concierge system 140.

Additionally, the data collection module 200 collects order data, which is information or data describing characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The data collection module 200 also collects marketplace data, which is information or data describing a state of a marketplace at a particular time. For example, marketplace data for a particular time may describe the time of day, other orders placed with the online concierge system 140 (e.g., a number of orders, a geographic region associated with the orders, retailers associated with the orders, a number of items included in each order, etc.), a busyness associated with one or more retailer locations from which one or more items included in a new or existing order are to be collected (e.g., an amount of congestion associated with checking out or a parking lot at the retailer location(s)), or any other suitable types of information. The data collection module 200 may collect marketplace data from one or more picker client devices 110, one or more retailer computing systems 120, the prediction module 223 (described below), or any other suitable source.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. In this example, the content presentation module 210 then displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. Components of the order management module 220 include: a request module 221, a progress/routing module 222, a prediction module 223, a cost determination module 224, an order assignment module 225, an interface module 226, a communication module 227, and a payment module 228, which are further described below.

The request module 221 receives requests to service orders or “service requests” from customer client devices 100. A service request for an order may include various types of information describing the order. For example, a service request may describe a retailer location from which one or more items included in an order are to be collected (e.g., a name and an address of the retailer location), the item(s) to be collected (e.g., a name, a brand, a quantity, a weight, a volume, etc. of each item), and instructions for collecting the item(s). As an additional example, a service request may include a payment amount associated with servicing an order (e.g., a payrate, a tip amount, etc.), information describing a delivery location for the order (e.g., a delivery address, whether the delivery location is a residence or a business or includes stairs, etc.), information describing a delivery timeframe for the order, or any other suitable types of information.

The request module 221 also determines whether the order assignment module 225 (described below) has assigned one or more new orders to a batch of existing orders and generates add-on requests based on the determination. A batch is a set of orders to be serviced together as a single job, while an add-on request is a request to add one or more new orders to a batch of existing orders. The request module 221 may generate an add-on request upon determining that the order assignment module 225 has assigned one or more new orders to a batch of existing orders. Furthermore, if the request module 221 generates an add-on request to add a new order to a batch of existing orders, the new order may include one or more items to be collected from one or more retailer locations that are different from one or more retailer locations from which one or more items included in the batch of existing orders are to be collected. For example, suppose that the request module 221 generates an add-on request to add a new order to a batch of existing orders. In this example, items included in the batch of existing orders are to be collected from a first retailer location, while one or more items included in the new order may be collected from the first retailer location or from a second retailer location that is near the first retailer location.

Once an add-on request has been generated by the request module 221, the interface module 226 may send it for display to a picker client device 110 associated with a picker servicing a batch of existing orders (e.g., as a push notification, as a text message, etc.). The picker may then accept the add-on request for servicing. For example, if an add-on request is sent to a picker client device 110 associated with a picker as a push notification, upon clicking on the notification, the picker may be presented with options to accept or decline the add-on request.

In some embodiments, the interface module 226 determines whether to send an add-on request for display to a picker client device 110 associated with a picker servicing a batch of existing orders. The interface module 226 may make this determination based on a number of add-on requests recently sent to the picker client device 110, a frequency with which add-on requests are being sent to the picker client device 110, or any other suitable types of information. For example, the interface module 226 may determine that an add-on request should not be sent to a picker client device 110 if at least three add-on requests have been sent to the picker client device 110 within the last hour. In the above example, if fewer than three add-on requests have been sent to the picker client device 110 within the last hour, the interface module 226 may determine that the add-on request may be sent to the picker client device 110. The interface module 226 may then send the add-on request to the picker client device 110 upon determining that the add-on request may be sent. Alternatively, if the interface module 226 determines that the add-on request should not be sent to the picker client device 110, the interface module 226 may communicate this to the order assignment module 225, which may then reassign one or more new orders associated with the add-on request to a different batch. Similarly, if the interface module 226 sends the add-on request to the picker client device 110, but the picker declines the add-on request or does not accept it within a threshold amount of time, the interface module 226 may communicate this to the order assignment module 225, which may then reassign the new order(s) associated with the add-on request to a different batch.

The order assignment module 225 assigns new orders to batches of orders by assigning each new order to one of multiple batches of orders. The batches of orders to which the order assignment module 225 may assign a new order may include batches of existing orders that are being serviced by pickers and batches of new orders that have not yet been assigned to pickers. The order assignment module 225 may assign one or more new orders to a batch of orders based on a cost associated with sending an add-on request to a picker client device 110 determined by the cost determination module 224, as further described below. For example, the order assignment module 225 may assign one or more new orders to a batch of existing orders being serviced by a picker if a cost associated with sending an add-on request to a picker client device 110 associated with the picker determined by the cost determination module 224 is less than a threshold cost. Alternatively, in the above example, the order assignment module 225 may not assign the new order(s) to the batch of existing orders being serviced by the picker if the cost is more than the threshold cost, and may instead assign the new order(s) to a batch of existing orders being serviced by another picker or to a batch of new orders that have not yet been assigned to a picker. In some embodiments, the order assignment module 225 assigns one or more new orders to a batch using an algorithm that minimizes a total cost associated with sending requests (e.g., service requests for batches of new orders and/or add-on requests) to picker client devices 110 based on a set of constraints. For example, the order assignment module 225 may assign one or more new orders to a batch using an optimization algorithm that minimizes a total cost associated with sending service requests for batches of new orders and add-on requests to picker client devices 110 based on a constraint that every new order is assigned to exactly one batch.

The order assignment module 225 assigns batches of orders to pickers for service based on picker data. For example, the order assignment module 225 assigns a batch of orders to a picker based on the picker's location and the retailer location from which the ordered items are to be collected. The order assignment module 225 may also assign a batch of orders to a picker based on how many items are in each order, a vehicle operated by the picker, one or more delivery locations, the picker's preferences for how far to travel to deliver an order, the picker's ratings by customers, or how often a picker agrees to service a batch of orders.

In some embodiments, the order assignment module 225 determines when to assign a batch of orders to a picker based on a delivery timeframe requested by each customer who placed an order included in the batch. The order assignment module 225 computes an estimated amount of time that it would take for a picker to collect the items for each order and deliver the ordered items to the delivery location for the order. The order assignment module 225 assigns the batch of orders to a picker at a time such that, if the picker immediately services the batch, the picker is likely to deliver each order at a time within the timeframe. Thus, when the request module 221 receives a service request for an order, the order assignment module 225 may delay in assigning a batch including the order to a picker if the timeframe is far enough in the future.

When the order assignment module 225 assigns a batch of new orders to a picker, the interface module 226 transmits a service request for the batch to a picker client device 110 associated with the picker. Similarly, when the order assignment module 225 assigns one or more new orders to a batch of existing orders being serviced by a picker, the interface module 226 transmits an add-on request for the new order(s) to a picker client device 110 associated with the picker. The interface module 226 may also transmit navigation instructions from the picker's current location to a retailer location associated with an order included in the batch. If the batch includes items to collect from multiple retailer locations, information transmitted by the interface module 226 identifies the retailer locations to the picker and may also specify a sequence in which the picker should visit the retailer locations.

The progress/routing module 222 receives information describing the progress of a picker servicing a batch of orders. Information describing the progress of a picker may indicate a location associated with the picker, a state of the picker (e.g., whether the picker is currently driving, collecting items, checking out at a retailer location, arriving at a retailer location or a delivery location, etc.), or a step associated with a state of the picker (e.g., collecting the third out of 10 items included in an order). Information describing the progress of a picker also may indicate tasks involved in fulfilling an order that have or have not been completed (e.g., items that have or have not yet been collected, orders that have or have not been delivered, etc.) or any other suitable types of information.

The progress/routing module 222 may receive information describing the progress of a picker by tracking the location of the picker through the picker client device 110 to determine when the picker arrives at a retailer location. When the picker arrives at the retailer location, the interface module 226 transmits a corresponding order to the picker client device 110 for display to the picker. As the picker uses the picker client device 110 to collect items at the retailer location, the progress/routing module 222 receives item identifiers for items that the picker has collected for the order. In some embodiments, the progress/routing module 222 receives images of items from the picker client device 110 and applies computer vision techniques to the images to identify the items depicted by the images. The progress/routing module 222 may track the progress of the picker as the picker collects items for an order and may transmit progress updates to the customer client device 100 that describe which items have been collected for the customer's order.

In some embodiments, the progress/routing module 222 also may receive information describing the progress of a picker by tracking the location of the picker within a retailer location. The progress/routing module 222 uses sensor data from the picker client device 110 or from sensors in the retailer location to determine the location of the picker in the retailer location. The progress/routing module 222 may transmit instructions to the picker client device 110 to display a map of the retailer location indicating where in the retailer location the picker is located. Additionally, the progress/routing module 222 may instruct the picker client device 110 to display the locations of items for the picker to collect, and the interface module 226 may display navigation instructions for how the picker can travel from their current location to the location of a next item to collect for an order.

The progress/routing module 222 also may determine when the picker has collected all of the items for an order. For example, the progress/routing module 222 may receive a message from the picker client device 110 indicating that all of the items for an order have been collected. Alternatively, the progress/routing module 222 may receive item identifiers for items collected by the picker and determine when all of the items in an order have been collected. When the progress/routing module 222 determines that the picker has completed an order, the interface module 226 transmits the delivery location for the order to the picker client device 110. The interface module 226 may also transmit navigation instructions to the picker client device 110 that specify how to travel from the retailer location to the delivery location, or to a subsequent retailer location for further item collection. The progress/routing module 222 tracks the location of the picker as the picker travels to the delivery location for an order, and updates the customer with the location of the picker so that the customer can track the progress of their order. In some embodiments, the progress/routing module 222 computes an estimated time of arrival for the picker at the delivery location and provides the estimated time of arrival to the customer.

In embodiments in which information describing the progress of a picker received by the progress/routing module 222 indicates a state of the picker, the progress/routing module 222 may infer the state of the picker based on the information. For example, based on information received from a picker client device 110 indicating a speed associated with the picker client device 110 that is greater than five miles an hour or information indicating the picker client device 110 has established a Bluetooth connection to a vehicle operated by the picker, the progress/routing module 222 may infer that the picker is driving. As an additional example, by tracking the location of a picker within a retailer location, the progress/routing module 222 may infer that the picker is checking out at the retailer location if the picker's location corresponds to a checkout stand.

The prediction module 223 may identify various types of information that it may use to predict a likelihood that a picker servicing a batch of existing orders will accept an add-on request to add one or more new orders to the batch of existing orders. Examples of such types of information include a set of attributes of the picker, a set of attributes of the new order(s) and one or more existing orders being serviced by the picker, or any other suitable types of information. The prediction module 223 may identify this information based on information received from a picker client device 110, other components of the online concierge system 140, or any other suitable source. For example, the prediction module 223 may identify a set of attributes of a picker based on picker data stored in the data store 240 including an average rate at which the picker collects items and an average number of hours the picker services orders (e.g., per day, on a given day of the week, etc.). As an additional example, based on order data stored in the data store 240, the prediction module 223 may identify a set of attributes of one or more new orders and one or more existing orders included in a batch of existing orders being serviced by a picker. In this example, the set of attributes may include a delivery location associated with each new or existing order, one or more items included in each new or existing order, an amount of pay associated with each new or existing order, a delivery timeframe for each new or existing order, etc.

The prediction module 223 also may determine the current marketplace state. The current marketplace state may describe the time of day, other orders placed with the online concierge system 140, a busyness associated with one or more retailer locations from which one or more items included in a new or existing order are to be collected (e.g., an amount of congestion associated with checking out or a parking lot at the retailer location(s)), or any other suitable types of information. The prediction module 223 may determine the current marketplace state based on various types of information received from other components of the online concierge system 140, one or more customer client devices 100, one or more picker client devices 110, one or more retailer computing systems 120, or any other suitable source. For example, suppose that information received from the progress/routing module 222 indicates that a picker is driving, but the picker has been associated with a location corresponding to a parking lot of a retailer location for the last 10 minutes. In this example, the prediction module 223 may determine that the parking lot of the retailer location is likely congested. As an additional example, if several service requests for new orders including items to be collected from a retailer location are received by the request module 221 and information received from the progress/routing module 222 indicates that pickers in a checking out state at the retailer location are in this state for more than a threshold amount of time, the prediction module 223 may determine that the retailer location is likely busy. The prediction module 223 may communicate information describing the current marketplace state to the data collection module 200, which may store this information in the data store 240 in association with the current time.

The prediction module 223 also predicts a likelihood that a picker servicing a batch of existing orders will accept an add-on request to add one or more new orders to the batch of existing orders. The prediction module 223 may predict the likelihood based on various types of information. Examples of such types of information include a set of attributes of the picker, information describing the progress of the picker with respect to servicing the batch of existing orders, a set of attributes of the new order(s) and one or more existing orders included in the batch of existing orders, the current marketplace state, etc. In some embodiments, if the likelihood predicted by the prediction module 223 is less than a threshold likelihood, the add-on request may not be sent to a picker client device 110 associated with the picker. For example, if the likelihood is less than the threshold likelihood, the cost determination module 224 (described below) may not determine a cost associated with sending the add-on request to the picker client device 110. As an additional example, if the likelihood is less than the threshold likelihood, the interface module 226 may not send the add-on request to the picker client device 110 regardless of the cost determined by the cost determination module 224.

The following examples illustrate how the prediction module 223 predicts a likelihood that a picker servicing a batch of existing orders will accept an add-on request to add one or more new orders to the batch of existing orders. Suppose, for example, that attributes of a new order and of each existing order included among a batch of existing orders being serviced by a picker describe one small item included in the new order to be collected from a retailer location and a moderate number of items included in the batch of existing orders to be collected from the same retailer location. In this example, suppose also that information describing the progress of the picker indicates the picker is at the retailer location and is almost finished collecting the items included in the batch of existing orders and that information describing the current marketplace state indicates that the retailer location is not very busy. In the above example, suppose also that attributes of the picker indicate that the picker has been servicing orders for fewer than an average number of hours they service orders on a given day and that the picker is willing to service orders during a timeframe in which the new order is to be delivered. Continuing with this example, based on the attributes of the picker, the information describing the progress of the picker, the attributes of the new order and each existing order, and the current marketplace state, the prediction module 223 may predict a high likelihood that the picker will accept an add-on request to add the new order to the batch of existing orders. Alternatively, in the above example, suppose that the information describing the progress of the picker indicates the picker is not almost finished delivering the existing orders, that the information describing the current marketplace state indicates that the retailer location is very busy, and that the attributes of the new order describe several large items to be collected from a different retailer location. In this example, suppose also that the attributes of the picker indicate that the picker has already been servicing orders for more than the average number of hours they service orders on a given day. Continuing with this example, based on the attributes of the picker, the information describing the progress of the picker, the attributes of the new order and each existing order, and the current marketplace state, the prediction module 223 may predict a low likelihood that the picker will accept an add-on request to add the new order to the batch of existing orders.

The prediction module 223 may predict a likelihood that a picker servicing a batch of existing orders will accept an add-on request to add one or more new orders to the batch of existing orders using an add-on acceptance prediction model. The add-on acceptance prediction model is a machine learning model trained to predict a likelihood that a picker servicing a batch of existing orders will accept an add-on request to add one or more new orders to the batch of existing orders. To use the add-on acceptance prediction model, the prediction module 223 may access the model (e.g., from the data store 240) and apply the model to a set of inputs. The set of inputs may include various types of information described above (e.g., a set of attributes of the picker, information describing the progress of the picker with respect to servicing the batch of existing orders, a set of attributes of the new order(s) and one or more existing orders included in the batch of existing orders, the current marketplace state, etc.). The prediction module 223 may then receive an output corresponding to the predicted likelihood that the picker servicing the batch of existing orders will accept an add-on request to add the new order(s) to the batch of existing orders. For example, the prediction module 223 may receive an output from the add-on acceptance prediction model corresponding to a value (e.g., a score, a percentage, etc.) in which the value is proportional to a likelihood that a picker servicing a batch of existing orders will accept an add-on request to add one or more new orders to the batch of existing orders. In some embodiments, the add-on acceptance prediction model may be trained by the machine learning training module 230, as further described below.

The cost determination module 224 determines a cost associated with sending an add-on request to a picker client device 110 associated with a picker. In some embodiments, the cost is a dollar value associated with servicing one or more new orders associated with the add-on request. For example, the cost may include an amount of earnings for a picker for servicing a new order. The cost determination module 224 may determine the cost based on a likelihood predicted by the prediction module 223 that the picker will accept the add-on request to add the order(s) to a batch of existing orders being serviced by the picker. The cost may be an expected cost of servicing the new order(s), which the cost determination module 224 may compute based on a product of the likelihood that the picker will accept the add-on request and an acceptance cost associated with servicing the new order(s) by the picker (e.g., an amount of earnings for the picker associated with servicing the new order(s)). The cost determination module 224 also may compute the expected cost based on a product of a likelihood that the picker will not accept the add-on request and a rejection cost associated with not having the new order(s) serviced by the picker (e.g., a default amount of earnings for a different picker to service the new order). For example, the cost determination module 224 may compute the expected cost to be:

$$( likelihood of acceptance * acceptance cost ) + ( \frac{1}{likelihood of acceptance} * rejection cost ) .$$

In some embodiments, the cost determination module 224 also determines a cost associated with sending a service request for a batch including one or more new orders to a picker client device 110 associated with a picker. In such embodiments, the cost determination module 224 determines the cost in a manner analogous to that described above.

In some embodiments, the communication module 227 facilitates communication between the customer client device 100 and the picker client device 110. As noted above, a customer may use a customer client device 100 to send a message to the picker client device 110. The communication module 227 receives the message from the customer client device 100 and transmits the message to the picker client device 110 for presentation to the picker. The picker may use the picker client device 110 to send a message to the customer client device 100 in a similar manner.

The payment module 228 coordinates payment by the customer for the order. The payment module 228 uses payment information provided by the customer (e.g., a credit card number or a bank account) to receive payment for the order. In some embodiments, the payment module 228 stores the payment information for use in subsequent orders by the customer. The payment module 228 computes a total cost for the order and charges the customer that cost. The payment module 228 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model is used by the machine learning model to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

In embodiments in which the prediction module 223 accesses the add-on acceptance prediction model that is trained to predict a likelihood that a picker servicing a batch of existing orders will accept an add-on request to add one or more new orders to the batch of existing orders, the machine learning training module 230 may train the add-on acceptance prediction model. The machine learning training module 230 may train the add-on acceptance prediction model via supervised learning (e.g., using a gradient boosted decision tree classifier) based on one or more types of historical data (e.g., historical picker data, historical marketplace state data, historical order data, etc.), one or more types of attributes (e.g., attributes of previous orders, attributes of pickers, etc.), or any other suitable types of information. For example, the machine learning training module 230 may train the add-on acceptance prediction model based on historical picker data describing acceptance by pickers of add-on requests to add new orders to batches of existing orders being serviced by the pickers, acceptance by pickers of service requests for batches of new orders, etc. The add-on acceptance prediction model may be retrained as more data (e.g., information describing whether add-on requests are accepted, information describing each add-on request, etc.) are received. In this way, once the model is initially trained, it can be repeatedly used to make predictions and those predictions coupled with the observed actual events used to retrain the model. Through this process of training, acquiring data, and retraining, the computer thus continues to improve at its prediction function.

To illustrate an example of how the add-on acceptance prediction model may be trained, suppose that the machine learning training module 230 receives a set of training examples. In this example, the set of training examples may include attributes of pickers, such as each picker's location at the time an add-on request was sent to a picker client device 110 associated with the picker, the progress of each picker servicing a batch of existing orders at the time the add-on request was sent, an average rate at which each picker collects items included in orders, an average number of hours per day each picker services orders, etc. In this example, the set of training examples also may include attributes of each new order associated with each add-on request and each existing order being serviced by a picker (e.g., number of items included in each order, a payment amount, a delivery location, a delivery timeframe, etc.), as well as information describing a marketplace state each time an add-on request was sent to a picker client device 110 associated with a picker (e.g., the time of day, a busyness of a retailer location associated with each new and existing order, a congestion of a parking lot of each retailer location, etc.). In the above example, the machine learning training module 230 also may receive labels which represent expected outputs of the add-on acceptance prediction model, in which a label indicates whether each picker accepted an add-on request sent to a picker client device 110 associated with the picker. Continuing with this example, the machine learning training module 230 may then train the add-on acceptance prediction model based on the attributes as well as the labels by comparing its output from input data of each training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In situations in which the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, picker data, and marketplace data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

Assigning a New Order Placed with an Online Concierge System to a Batch of Existing Orders being Serviced by a Picker

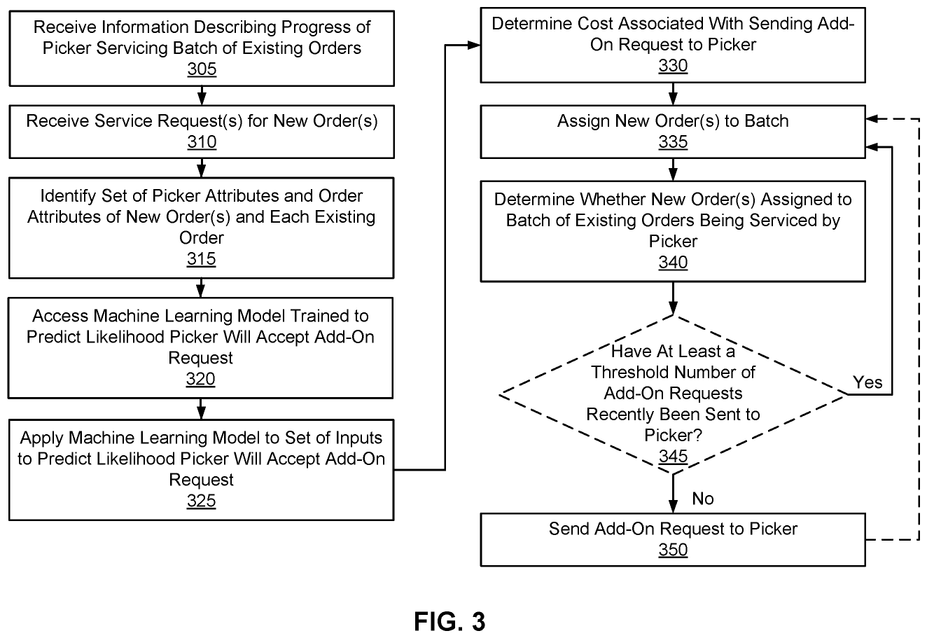

FIG. 3 is a flowchart for a method for assigning a new order placed with an online concierge system 140 to a batch of existing orders being serviced by a picker, in accordance with one or more embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system 140 without human intervention.

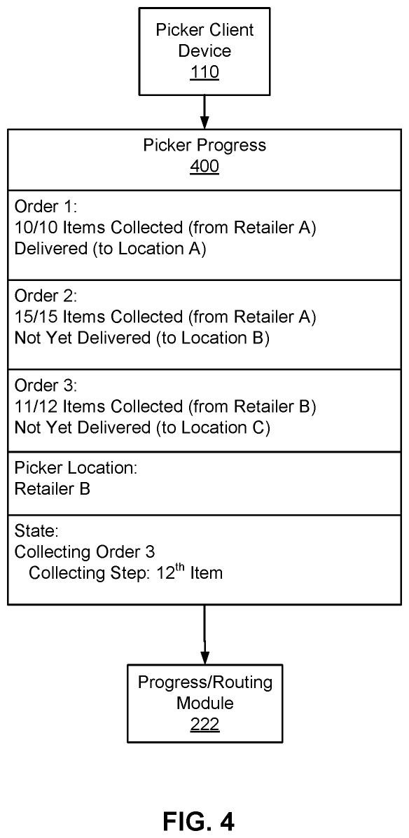

The online concierge system 140 receives 305 (e.g., via the progress/routing module 222) information describing the progress of a picker servicing a batch of existing orders. The information describing the progress of the picker may indicate a location associated with the picker, a state of the picker (e.g., whether the picker is currently driving, collecting items, checking out at a retailer location, arriving at a retailer location or a delivery location, etc.), or a step associated with a state of the picker (e.g., collecting the third out of 10 items included in an existing order). The information describing the progress of a picker also may indicate tasks involved in fulfilling an existing order that have or have not been completed (e.g., items that have or have not yet been collected, existing orders that have or have not been delivered, etc.) or any other suitable types of information. FIG. 4 illustrates an example of information describing the progress 400 of a picker servicing a batch of existing orders, in accordance with one or more embodiments. As shown in this example, the information describing the progress 400 of the picker indicates that the batch of existing orders being serviced by the picker includes three orders (Order 1, Order 2, and Order 3). In this example, the information describing the progress 400 of the picker also indicates that the picker has collected all the items included in Order 1 and Order 2 and has collected 11 of the 12 items included in Order 3. Furthermore, in this example, the information describing the progress 400 of the picker indicates that the picker is at Retailer B, where the picker is currently collecting the 12th item included in Order 3. In the above example, the information describing the progress 400 of the picker also indicates that the picker has delivered Order 1, but has not yet delivered Order 2 or Order 3.

The online concierge system 140 may receive 305 the information describing the progress 400 of the picker by tracking the location of the picker as the picker travels to a retailer location or a delivery location for an existing order (e.g., via a picker client device 110 associated with the picker), or as the picker travels within a retailer location (e.g., using sensor data from the picker client device 110 or from sensors in the retailer location). The online concierge system 140 also may receive 305 this information by tracking the progress 400 of the picker as the picker collects items for an existing order. For example, the online concierge system 140 may receive 305 the information describing the progress 400 of the picker in the form of item identifiers for items included in an existing order that the picker has collected or in the form of a message indicating that all of the items for an existing order have been collected from the picker client device 110 associated with the picker. In the above example, the online concierge system 140 also or alternatively may receive 305 the information describing the progress 400 of the picker in the form of images of items included in the existing order that the picker has collected, which the online concierge system 140 may then identify by applying computer vision techniques to the images.

In embodiments in which the information describing the progress 400 of the picker received 305 by the online concierge system 140 indicates a state of the picker, the online concierge system 140 may infer (e.g., using the progress/routing module 222) the state of the picker based on the information. For example, based on information received 305 from the picker client device 110 indicating a speed associated with the picker client device 110 that is greater than five miles an hour or information indicating the picker client device 110 has established a Bluetooth connection to a vehicle operated by the picker, the online concierge system 140 may infer that the picker is driving. As an additional example, by tracking the location of the picker within a retailer location, the online concierge system 140 may infer that the picker is checking out at the retailer location if the picker's location corresponds to a checkout stand.

Referring back to FIG. 3, the online concierge system 140 then receives 310 (e.g., via the request module 221) one or more service requests for one or more new orders from one or more customer client devices 100. The service request(s) may include various types of information describing the new order(s). For example, the service request(s) may describe one or more retailer locations from which one or more items included in the new order(s) are to be collected (e.g., a name and an address of each retailer location), the item(s) to be collected (e.g., a name, a brand, a quantity, a weight, a volume, etc. of each item), and instructions for collecting the item(s). As an additional example, the service request(s) may include a payment amount associated with servicing each new order (e.g., a payrate, a tip amount, etc.), information describing a delivery location for each new order (e.g., a delivery address, whether the delivery location is a residence or a business or includes stairs, etc.), information describing a delivery timeframe for each new order, or any other suitable types of information.

The online concierge system 140 then identifies 315 (e.g., using the prediction module 223) various types of information that it may use to predict a likelihood that the picker will accept an add-on request to add the new order(s) to the batch of existing orders. Examples of such types of information include a set of attributes of the picker, a set of attributes of the new order(s) and one or more existing orders being serviced by the picker, or any other suitable types of information. The online concierge system 140 may identify 315 this information based on information received from the picker client device 110 or any other suitable source. For example, the online concierge system 140 may identify 315 a set of attributes of the picker based on picker data (e.g., stored in the data store 240) including an average rate at which the picker collects items and an average number of hours the picker services orders (e.g., per day, on a given day of the week, etc.). As an additional example, based on order data (e.g., stored in the data store 240), the online concierge system 140 may identify 315 a set of attributes of each new order and each existing order included in the batch of existing orders being serviced by the picker. In this example, the set of attributes may include a delivery location associated with each new or existing order, one or more items included in each new or existing order, an amount of pay associated with each new or existing order, a delivery timeframe for each new or existing order, etc.

In some embodiments, the online concierge system 140 also may determine (e.g., using the prediction module 223) the current marketplace state. The current marketplace state may describe the time of day, other orders placed with the online concierge system 140, a busyness associated with one or more retailer locations from which one or more items included in the new order(s) or the batch of existing orders being serviced by the picker are to be collected (e.g., an amount of congestion associated with checking out or a parking lot at the retailer location(s)), or any other suitable types of information. The online concierge system 140 may determine the current marketplace state based on various types of information received from one or more customer client devices 100, one or more picker client devices 110, one or more retailer computing systems 120, or any other suitable source. For example, suppose that the information describing the progress 400 of the picker received 305 by the online concierge system 140 indicates that the picker is driving, but the picker has been associated with a location corresponding to a parking lot of a retailer location for the last 10 minutes. In this example, the online concierge system 140 may determine that the parking lot of the retailer location is likely congested. As an additional example, if several service requests for new orders including items to be collected from a retailer location are received 310 by the online concierge system 140 and information received by the online concierge system 140 indicates that pickers in a checking out state at the retailer location are in this state for more than a threshold amount of time, the online concierge system 140 may determine that the retailer location is likely busy. The online concierge system 140 may store information describing the current marketplace state in association with the current time (e.g., in the data store 240).

The online concierge system 140 then predicts (e.g., using the prediction module 223) a likelihood that the picker servicing the batch of existing orders will accept an add-on request to add the new order(s) to the batch of existing orders. The online concierge system 140 may predict the likelihood based on various types of information. Examples of such types of information include a set of attributes of the picker, the information describing the progress 400 of the picker with respect to servicing the batch of existing orders, a set of attributes of the new order(s) and one or more existing orders included in the batch of existing orders, the current marketplace state, etc. In some embodiments, if the likelihood predicted by the online concierge system 140 is less than a threshold likelihood, the add-on request may not be sent to the picker client device 110 associated with the picker. For example, if the likelihood is less than the threshold likelihood, the online concierge system 140 may not determine a cost associated with sending the add-on request to the picker client device 110 or the online concierge system 140 may not send the add-on request to the picker client device 110 regardless of the cost, as described below (in steps 330 and 350, respectively).

The following examples illustrate how the online concierge system 140 predicts the likelihood that the picker servicing the batch of existing orders will accept the add-on request to add the new order(s) to the batch of existing orders. Suppose, for example, that attributes of a new order and of each existing order included among the batch of existing orders being serviced by the picker describe one small item included in the new order to be collected from a retailer location and a moderate number of items included in the batch of existing orders to be collected from the same retailer location. In this example, suppose also that the information describing the progress 400 of the picker indicates the picker is at the retailer location and is almost finished collecting the items included in the batch of existing orders and that information describing the current marketplace state indicates that the retailer location is not very busy. In the above example, suppose also that attributes of the picker indicate that the picker has been servicing orders for fewer than an average number of hours they service orders on a given day and that the picker is willing to service orders during a timeframe in which the new order is to be delivered. Continuing with this example, based on the attributes of the picker, the information describing the progress 400 of the picker, the attributes of the new order and each existing order, and the current marketplace state, the online concierge system 140 may predict a high likelihood that the picker will accept the add-on request to add the new order to the batch of existing orders. Alternatively, in the above example, suppose that the information describing the progress 400 of the picker indicates the picker is not almost finished delivering the existing orders, that the information describing the current marketplace state indicates that the retailer location is very busy, and that the attributes of the new order describe several large items to be collected from a different retailer location. In this example, suppose also that the attributes of the picker indicate that the picker has already been servicing orders for more than the average number of hours they service orders on a given day. Continuing with this example, based on the attributes of the picker, the information describing the progress 400 of the picker, the attributes of the new order and each existing order, and the current marketplace state, the online concierge system 140 may predict a low likelihood that the picker will accept the add-on request to add the new order to the batch of existing orders.

The online concierge system 140 may predict the likelihood that the picker servicing the batch of existing orders will accept the add-on request to add the new order(s) to the batch of existing orders using an add-on acceptance prediction model. The add-on acceptance prediction model is a machine learning model trained to predict a likelihood that a picker servicing a batch of existing orders will accept an add-on request to add one or more new orders to the batch of existing orders. To use the add-on acceptance prediction model, the online concierge system 140 may access 320 (e.g., using the prediction module 223) the model (e.g., from the data store 240) and apply 325 (e.g., using the prediction module 223) the model to a set of inputs. The set of inputs may include various types of information described above (e.g., the set of attributes of the picker, the information describing the progress 400 of the picker with respect to servicing the batch of existing orders, the set of attributes of the new order(s) and existing order(s) included in the batch of existing orders, the current marketplace state, etc.). The online concierge system 140 may then receive an output corresponding to the predicted likelihood that the picker servicing the batch of existing orders will accept the add-on request to add the new order(s) to the batch of existing orders. For example, the online concierge system 140 may receive an output from the add-on acceptance prediction model corresponding to a value (e.g., a score, a percentage, etc.) in which the value is proportional to the likelihood that the picker servicing the batch of existing orders will accept the add-on request to add the new order(s) to the batch of existing orders. In some embodiments, the add-on acceptance prediction model may be trained by the online concierge system 140 (e.g., using the machine learning training module 230).

The online concierge system 140 then determines 330 (e.g., using the cost determination module 224) a cost associated with sending the add-on request to the picker client device 110 associated with the picker. In some embodiments, the cost is a dollar value associated with servicing the new order(s). For example, the cost may include an amount of earnings for the picker for servicing the new order. The online concierge system 140 may determine 330 the cost based on the likelihood that the picker will accept the add-on request predicted by the online concierge system 140. The cost may be an expected cost of servicing the new order(s), which the online concierge system 140 may compute based on a product of the likelihood that the picker will accept the add-on request and an acceptance cost associated with servicing the new order(s) by the picker (e.g., an amount of earnings for the picker associated with servicing the new order(s)). The online concierge system 140 also may compute the expected cost based on a product of a likelihood that the picker will not accept the add-on request and a rejection cost associated with not having the new order(s) serviced by the picker (e.g., a default amount of earnings for a different picker to service the new order). For example, the online concierge system 140 may compute the expected cost to be:

$$( likelihood of acceptance * acceptance cost ) + ( \frac{1}{likelihood of acceptance} * rejection cost ) .$$

In some embodiments, the online concierge system 140 also determines costs associated with sending requests (e.g., service requests for batches of new orders and/or add-on requests) to picker client devices 110 associated with other pickers. In such embodiments, the online concierge system 140 determines the cost associated with sending the requests in a manner analogous to that described above.

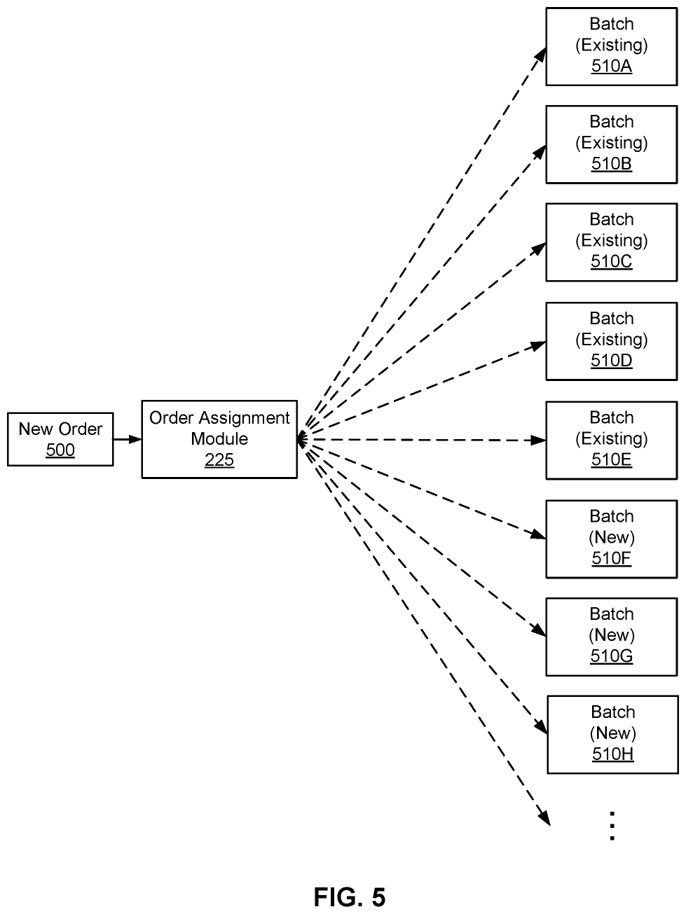

The online concierge system 140 then assigns 335 (e.g., using the order assignment module 225) the new order(s) to one of multiple batches of orders. FIG. 5 illustrates an example of assigning 335 a new order 500 to a batch 510 of orders included among multiple batches 510 of orders, in accordance with one or more embodiments. As shown in FIG. 5, the batches 510 of orders to which the online concierge system 140 may assign 335 the new order 500 may include batches 510A-E of existing orders that are being serviced by pickers and batches 510F-H of new orders 500 that have not yet been assigned 335 to pickers. The online concierge system 140 may assign 335 the new order(s) 500 to a batch 510 of orders based on the cost associated with sending the add-on request to the picker client device 110 determined 330 by the online concierge system 140. For example, the online concierge system 140 may assign 335 the new order(s) 500 to the batch 510 of existing orders being serviced by the picker if the cost associated with sending the add-on request to the picker client device 110 associated with the picker determined 330 by the online concierge system 140 is less than a threshold cost. Alternatively, in the above example, the online concierge system 140 may not assign 335 the new order(s) 500 to the batch 510 of existing orders being serviced by the picker if the cost is more than the threshold cost, and may instead assign 335 the new order(s) 500 to a batch 510 of existing orders being serviced by another picker or to a batch 510 of new orders 500 that have not yet been assigned 335 to a picker. In some embodiments, the online concierge system 140 assigns 335 the new order(s) 500 to a batch 510 using an algorithm that minimizes a total cost associated with sending requests (e.g., service requests for batches 510 of new orders 500 and/or add-on requests) to picker client devices 110 based on a set of constraints. For example, the online concierge system 140 may assign 335 the new order(s) 500 to a batch 510 using an optimization algorithm that minimizes a total cost associated with sending service requests for batches 510 of new orders 500 and add-on requests to picker client devices 110 based on a constraint that every new order 500 is assigned 335 to exactly one batch 510.

Referring again to FIG. 3, the online concierge system 140 determines 340 (e.g., using the request module 221) whether the new order(s) 500 have been assigned 335 to the batch 510 of existing orders being serviced by the picker. The online concierge system 140 may generate (e.g., using the request module 221) the add-on request for the new order(s) 500 upon determining 340 that the new order(s) 500 have been assigned 335 to the batch 510 of existing orders being serviced by the picker. Furthermore, if the online concierge system 140 generates the add-on request to add the new order(s) 500 to the batch 510 of existing orders, the new order(s) 500 may include one or more items to be collected from one or more retailer locations that are different from one or more retailer locations from which one or more items included in the batch 510 of existing orders are to be collected. For example, suppose that the online concierge system 140 generates the add-on request to add the new order(s) 500 to the batch 510 of existing orders being serviced by the picker. In this example, items included in the batch 510 of existing orders are to be collected from a first retailer location, while one or more items included in the new order(s) 500 may be collected from the first retailer location or from a second retailer location that is near the first retailer location.

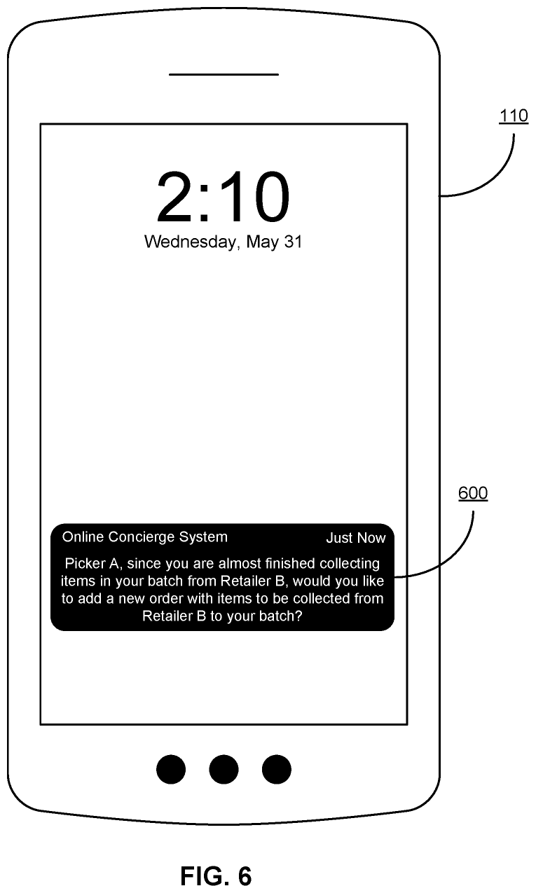

Once the add-on request has been generated by the online concierge system 140, the online concierge system 140 may send 350 (e.g., via the interface module 226) it for display to the picker client device 110 associated with the picker servicing the batch 510 of existing orders (e.g., as a push notification, as a text message, etc.). The picker may then accept the add-on request for servicing. FIG. 6 illustrates an example of an add-on request 600 to add a new order 500 to a batch 510 of existing orders being serviced by a picker, in accordance with one or more embodiments. As shown in FIG. 6, the add-on request 600 may be sent 350 to the picker client device 110 associated with the picker as a push notification. In this example, upon clicking on the notification, the picker may be presented with options to accept or decline the add-on request 600.

Referring once more to FIG. 3, in some embodiments, the online concierge system 140 determines 345 (e.g., using the interface module 226) whether to send 350 the add-on request 600 for display to the picker client device 110 and may then send 350 it based on the determination. The online concierge system 140 may make this determination based on a number of add-on requests 600 recently sent 350 to the picker client device 110, a frequency with which add-on requests 600 are being sent 350 to the picker client device 110, or any other suitable types of information. For example, the online concierge system 140 may determine 345 that the add-on request 600 should not be sent 350 to the picker client device 110 if at least three add-on requests 600 have been sent 350 to the picker client device 110 within the last hour. In the above example, if fewer than three add-on requests 600 have been sent 350 to the picker client device 110 within the last hour, the online concierge system 140 may determine 345 that the add-on request 600 may be sent 350 to the picker client device 110. The online concierge system 140 may then send 350 the add-on request 600 to the picker client device 110 upon determining 345 that the add-on request 600 may be sent 350. Alternatively, if the online concierge system 140 determines 345 that the add-on request 600 should not be sent 350 to the picker client device 110, the online concierge system 140 may then reassign the new order(s) 500 associated with the add-on request 600 to a different batch 510 (e.g., by proceeding back to step 335). Similarly, if the online concierge system 140 sends 350 the add-on request 600 to the picker client device 110, but the picker declines the add-on request 600 or does not accept it within a threshold amount of time, the online concierge system 140 may then reassign the new order(s) 500 associated with the add-on request 600 to a different batch 510 (e.g., by proceeding back to step 335).

### ADDITIONAL CONSIDERATIONS

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, at an online concierge system, information describing a progress of a picker servicing a set of existing orders;
receiving a service request for an order placed with the online concierge system;
identifying a set of picker attributes of the picker and a set of order attributes of the order and each existing order of the set of existing orders being serviced by the picker;
accessing a machine learning model trained to predict a likelihood that the picker will accept an add-on request to add the order to the set of existing orders being serviced by the picker, wherein the machine learning model is trained by:
receiving historical data describing acceptance, by pickers, of add-on requests to add orders to sets of existing orders being serviced by the pickers, and
training the machine learning model based at least in part on the historical data;
applying the machine learning model to a set of inputs to predict the likelihood that the picker will accept the add-on request to add the order to the set of existing orders being serviced by the picker, wherein the set of inputs comprises the set of picker attributes, the progress of the picker, and the set of order attributes of the order and each existing order of the set of existing orders being serviced by the picker;
determining a cost associated with sending the add-on request to a client device associated with the picker, the cost determined based at least in part on the predicted likelihood;
assigning the order to a set of orders included among a plurality of sets of orders based at least in part on the determined cost, wherein the plurality of sets of orders comprises the set of existing orders being serviced by the picker;
determining that the order is assigned to the set of existing orders being serviced by the picker; and
responsive to determining that the order is assigned to the set of existing orders being serviced by the picker, sending the add-on request to the client device associated with the picker, wherein sending the add-on request causes the client device to display the add-on request with an option for the picker to add the order to the set of existing orders.

2. The method of claim 1, wherein identifying the set of picker attributes of the picker comprises identifying one or more of: a location associated with the picker or a rate at which the picker collects items included in orders.

3. The method of claim 1, wherein identifying the set of order attributes comprises identifying one or more of: a delivery location associated with an order, one or more items included in an order, or an amount of pay associated with an order.

4. The method of claim 1, further comprising:
determining a current marketplace state, wherein the current marketplace state describes one or more of: a time of day, a set of additional orders placed with the online concierge system, a busyness associated with one or more retailer locations, or an amount of congestion associated with one or more retailer locations.

5. The method of claim 4, wherein applying the machine learning model to the set of inputs further comprises applying the machine learning model to the current marketplace state.

6. The method of claim 1, wherein assigning the order to a set of orders included among a plurality of sets of orders based at least in part on the determined cost comprises assigning the order to a set of orders included among a plurality of sets of orders based at least in part on an expected cost of servicing the order.

7. The method of claim 6, further comprising:
generating the expected cost of servicing the order based at least in part on a product of the likelihood that the picker will accept the add-on request and an acceptance cost associated with the picker servicing the order.

8. The method of claim 7, wherein generating the expected cost of servicing the order based on the acceptance cost comprises generating the acceptance cost based on an amount of earnings for the picker associated with servicing the order.

9. The method of claim 7, wherein generating the expected cost of servicing the order is further based at least in part on a product of a likelihood that the picker will not accept the add-on request and a rejection cost associated with the picker not servicing the order.

10. The method of claim 1, further comprising:
determining whether to send the add-on request to the client device associated with the picker based at least in part on a number of add-on requests to add orders to the set of existing orders being serviced by the picker previously sent to the client device associated with the picker within a threshold amount of time of a current time.

11. A computer program product comprising a non-transitory computer-readable storage medium having instructions encoded thereon that, when executed by a processor, cause the processor to perform steps comprising:
receiving, at an online concierge system, information describing a progress of a picker servicing a set of existing orders;
receiving a service request for an order placed with the online concierge system;
identifying a set of picker attributes of the picker and a set of order attributes of the order and each existing order of the set of existing orders being serviced by the picker;
accessing a machine learning model trained to predict a likelihood that the picker will accept an add-on request to add the order to the set of existing orders being serviced by the picker, wherein the machine learning model is trained by:
receiving historical data describing acceptance, by pickers, of add-on requests to add orders to sets of existing orders being serviced by the pickers, and
training the machine learning model based at least in part on the historical data;
applying the machine learning model to a set of inputs to predict the likelihood that the picker will accept the add-on request to add the order to the set of existing orders being serviced by the picker, wherein the set of inputs comprises the set of picker attributes, the progress of the picker, and the set of order attributes of the order and each existing order of the set of existing orders being serviced by the picker;
determining a cost associated with sending the add-on request to a client device associated with the picker, the cost determined based at least in part on the predicted likelihood;
assigning the order to a set of orders included among a plurality of sets of orders based at least in part on the determined cost, wherein the plurality of sets of orders comprises the set of existing orders being serviced by the picker;
determining that the order is assigned to the set of existing orders being serviced by the picker; and
responsive to determining that the order is assigned to the set of existing orders being serviced by the picker, sending the add-on request to the client device associated with the picker, wherein sending the add-on request causes the client device to display the add-on request with an option for the picker to add the order to the set of existing orders.

12. The computer program product of claim 11, wherein identifying the set of picker attributes of the picker comprises identifying one or more of: a location associated with the picker or a rate at which the picker collects items included in orders.

13. The computer program product of claim 11, wherein identifying the set of order attributes comprises identifying one or more of: a delivery location associated with an order, one or more items included in an order, or an amount of pay associated with an order.

14. The computer program product of claim 11, wherein the computer-readable storage medium further has instructions encoded thereon that, when executed by the processor, cause the processor to perform steps comprising:
determining a current marketplace state, wherein the current marketplace state describes one or more of: a time of day, a set of additional orders placed with the online concierge system, a busyness associated with one or more retailer locations, or an amount of congestion associated with one or more retailer locations.

15. The computer program product of claim 14, wherein applying the machine learning model to the set of inputs further comprises applying the machine learning model to the current marketplace state.

16. The computer program product of claim 11, wherein assigning the order to a set of orders included among a plurality of sets of orders based at least in part on the determined cost comprises assigning the order to a set of orders included among a plurality of sets of orders based at least in part on an expected cost of servicing the order.

17. The computer program product of claim 16, wherein the computer-readable storage medium further has instructions encoded thereon that, when executed by the processor, cause the processor to perform steps comprising:
generating the expected cost of servicing the order based at least in part on a product of the likelihood that the picker will accept the add-on request and an acceptance cost associated with the picker servicing the order.

18. The computer program product of claim 17, wherein generating the expected cost of servicing the order based on the acceptance cost comprises generating the acceptance cost based on an amount of earnings for the picker associated with servicing the order.

19. The computer program product of claim 17, wherein generating the expected cost of servicing the order is further based at least in part on a product of a likelihood that the picker will not accept the add-on request and a rejection cost associated with the picker not servicing the order.

20. A computer system comprising:
a processor; and
a non-transitory computer-readable storage medium storing instructions that, when executed by the processor, perform actions comprising:
receiving, at an online concierge system, information describing a progress of a picker servicing a set of existing orders;
receiving a service request for an order placed with the online concierge system;
identifying a set of picker attributes of the picker and a set of order attributes of the order and each existing order of the set of existing orders being serviced by the picker;
accessing a machine learning model trained to predict a likelihood that the picker will accept an add-on request to add the order to the set of existing orders being serviced by the picker, wherein the machine learning model is trained by:
receiving historical data describing acceptance, by pickers, of add-on requests to add orders to sets of existing orders being serviced by the pickers, and
training the machine learning model based at least in part on the historical data;
applying the machine learning model to a set of inputs to predict the likelihood that the picker will accept the add-on request to add the order to the set of existing orders being serviced by the picker, wherein the set of inputs comprises the set of picker attributes, the progress of the picker, and the set of order attributes of the order and each existing order of the set of existing orders being serviced by the picker;
determining a cost associated with sending the add-on request to a client device associated with the picker, the cost determined based at least in part on the predicted likelihood;
assigning the order to a set of orders included among a plurality of sets of orders based at least in part on the determined cost, wherein the plurality of sets of orders comprises the set of existing orders being serviced by the picker;
determining that the order is assigned to the set of existing orders being serviced by the picker, and
responsive to determining that the order is assigned to the set of existing orders being serviced by the picker, sending the add-on request to the client device associated with the picker, wherein sending the add-on request causes the client device to display the add-on request with an option for the picker to add the order to the set of existing orders.
